(19) United States
(12) Patent Application Publication
(10) Pub. No.: US 2009/0316089 A1
(43) Pub. Date: Dec. 24, 2009

(54) LIQUID CRYSTAL DISPLAY PANEL AND METHOD FOR FABRICATING THE SAME

(76) Inventors: Dong Uk Shin, Seoul (KR); Hea Jung Jung, Nonsan-si (KR)

Correspondence Address: BRINKS HOFER GILSON & LIONE, P.O. BOX 10395, CHICAGO, IL, 60610, US

(21) Appl. No.: 12/346,122

(22) Filed: Dec. 30, 2008

(30) Foreign Application Priority Data
Jun. 24, 2008 (KR) P 2008-59888

(51) Int. Cl. G02F 1/1339; G02F 1/1333

(52) U.S. Cl. 349/110; 349/153; 349/190

(57) ABSTRACT

The present disclosure relates to a liquid crystal display panel and a method for fabricating the same which can enhance adhesive force between a thin film transistor substrate and a color filter substrate. The liquid crystal display panel includes a black matrix formed on an upper substrate, a common electrode formed on the black matrix, a lower substrate having a thin film transistor formed thereon, the lower substrate facing the upper substrate, and a seal pattern portion overlapped with the black matrix and the upper substrate with the common electrode disposed therebetween for bonding the upper substrate and the lower substrate together.

### RELATED APPLICATIONS

This application claims the benefit of the Patent Korean Application No. P2008-059888, filed on Jun. 24, 2008, which is hereby incorporated by reference as if fully set forth herein.

### BACKGROUND

1. Field of the Disclosure

The present disclosure relates to a liquid crystal display panel and a method for fabricating the same, and more particularly, to a liquid crystal display panel and a method for fabricating the same which can enhance adhesive force between a thin film transistor substrate and a color filter substrate.

2. Discussion of the Related Art

Currently, various flat display devices are under development, which can reduce thickness and volume which are disadvantages of a cathode ray tube. As types of flat display devices, there are liquid crystal displays, plasma display panels, field emission displays, and electro-luminiscent displays.

The liquid crystal display panel is provided with the color filter substrate having a black matrix and a color filter array formed thereon and a thin film transistor substrate having a thin film transistor array with thin film transistors and a plurality of signal lines formed thereon bonded together with liquid crystals disposed therebetween. The liquid crystal display panel displays a desired image by applying an electric field to the liquid crystals having anisotropic dielectric between the two substrates and controlling an intensity of the electric field to control the quantity of a light passing through the substrate.

Along a periphery of a display region of the thin film transistor substrate, a seal line is formed for bonding the thin film transistor substrate and the color filter substrate, together. In this instance, if proper bonding of the thin film transistor substrate and the color filter substrate fails, problems, such as blackening of the liquid crystal display panel, defective filling of the liquid crystals, and so on, are caused.

### BRIEF SUMMARY

A liquid crystal display panel includes a black matrix formed on an upper substrate, a common electrode formed on the black matrix, a lower substrate having a thin film transistor formed thereon, the lower substrate facing the upper substrate, and a seal pattern portion overlapped with the black matrix and the upper substrate with the common electrode disposed therebetween for bonding the upper substrate and the lower substrate together.

In another aspect, a method for fabricating a liquid crystal display panel includes the steps of forming a black matrix on an upper substrate, forming a common electrode on the black matrix, forming a thin film transistor on a lower substrate to face the upper substrate, and forming a seal pattern portion to overlap with the black matrix and the upper substrate with the common electrode disposed therebetween for bonding the upper substrate and the lower substrate together.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a plan view of a liquid crystal display panel in accordance with an embodiment.

FIG. 2 illustrates a section across a line I-I′ of the liquid crystal display panel in accordance with the embodiment shown in FIG. 1.

FIGS. 3A to 3E illustrate a method for fabricating a liquid crystal display panel in accordance with an embodiment.

### DETAILED DESCRIPTION OF THE DRAWINGS AND THE PRESENTLY PREFERRED EMBODIMENTS

Reference will now be made in detail to the preferred embodiments, examples of which are illustrated in the accompanying drawings. Wherever possible, the same reference numbers will be used throughout the drawings to refer to the same or like parts.

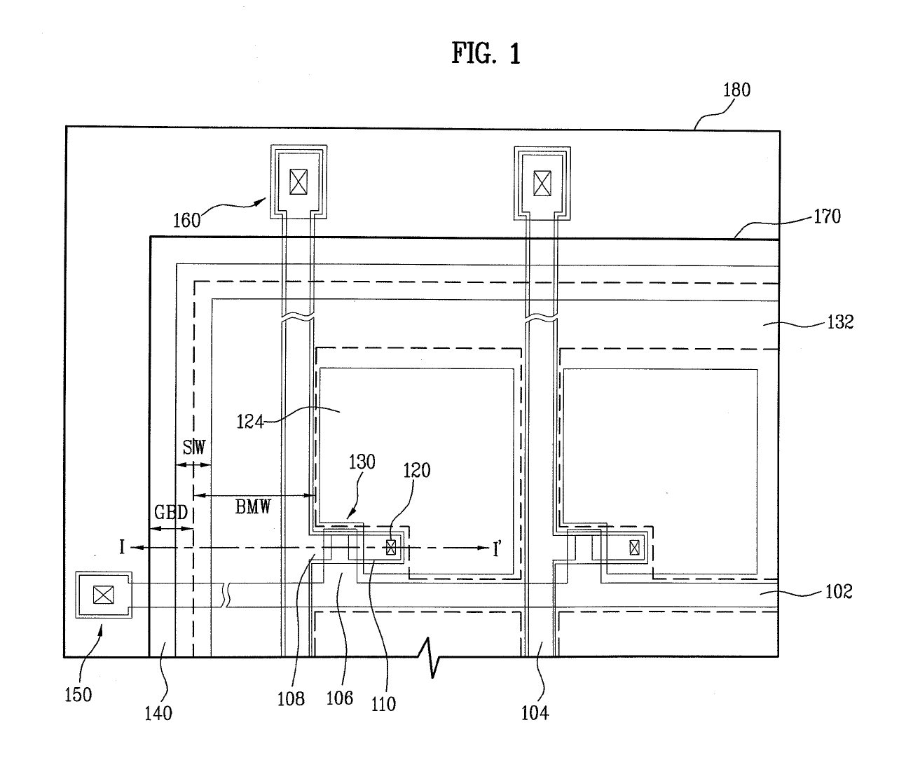

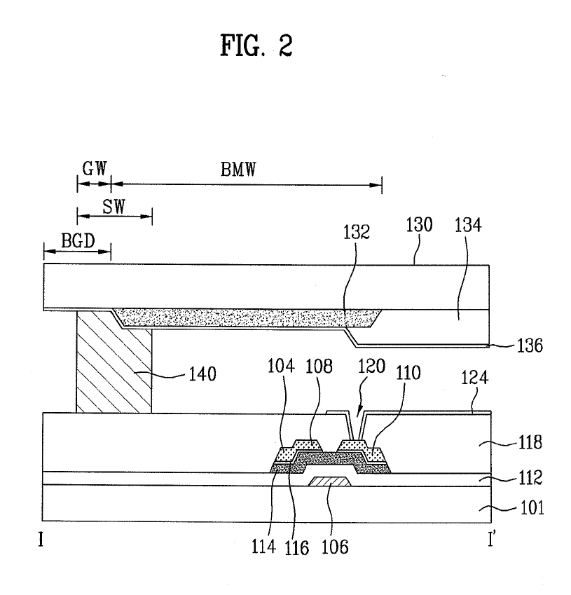

FIG. 1 illustrates a plan view of a liquid crystal display panel in accordance with an embodiment, and FIG. 2 illustrates a section across a line I-I′ of the liquid crystal display panel in accordance with the embodiment shown in FIG. 1.

Referring to FIGS. 1 and 2, the liquid crystal display panel includes a thin film transistor substrate 180, a color filter substrate 170, a seal pattern portion 140.

The color filter substrate 170 has with a color filter 134, a black matrix 132, and a common electrode 136.

The color filter 134 has red, green, and blue color filters R, G, B for producing colors. The red, green, and blue color filters R, G, B absorb or transmit lights of specific wavelengths by means of red, green and blue pigments, to produce red, green, and blue colors, respectively.

The black matrix 132 defines pixel regions at which the color filters 134 to be formed, and formed to overlap with gate lines 102, a data lines 104, and the thin film transistor TFT of the thin film transistor substrate 101. The black matrix 132 shields transmission of a light caused by unwanted liquid crystal alignment for improving a contrast of the liquid crystal display device, and shields direct incident of the light onto the thin film transistor TFT for preventing a current from leaking from the thin film transistor TFT. The black matrix 132 is formed to overlap with the seal pattern portion for some extent.

The common electrode 136 is formed on the color filter 136. The common electrode 136 applies a common voltage to the liquid crystals in response to a pixel voltage to the pixel electrode 124. For this, the common electrode 136 is formed of ITO (Indium Tin Oxide), or IZO (Indium Zinc Oxide), which is transparent and conductive.

The thin film transistor substrate 180 has thin film transistors TFT and pixel electrodes 124.

The thin film transistor TFT supplies a video signal from the data line 104 to the pixel electrode 124 in response to a scan signal from the gate line 102. For this, the thin film transistor TFT includes a gate electrode 106 connected to the gate line 102, a source electrode 108 connected to the data line 104, a drain electrode 110 connected to the pixel electrode 124, an active layer 114 of a semiconductor pattern overlapped with the gate electrode 106 with a gate insulating film 112 disposed therebetween for forming a channel between the source electrode 108 and the drain electrode 110, and an ohmic contact layer 116 of a semiconductor pattern formed on the active layer excluding the channel portion for making ohmic contact to the source electrode 108 and the drain electrode 110.

The gate line 102 supplies the scan signal from the gate driver to the gate electrode 106 of the thin film transistor T through a gate pad 150. The data line 104 supplies a video signal from a data driver to the source electrode 108 of the thin film transistor TFT through a data pad 160. The gate line 102 and the data line 104 are formed perpendicular to each other to define pixel regions.

The pixel electrode 124 is connected to the drain electrode 110 of the thin film transistor TFT through a contact hole 120, and formed on a protective film 118. The pixel electrode 124 is a transparent conductive layer. In this instance, upon reception of the video signal through the thin film transistor TFT, the pixel electrode 124 forms an electric field together with the common electrode 136 having the common voltage supplied thereto, so that an alignment of liquid crystal molecules between the two electrode 124 and 136 are changed, to change transmissivity of the light passing through the liquid crystal molecules, thereby producing a gray scale.

The protective film 118 is formed between the thin film transistor TFT and the pixel electrode 124 for protecting the data line 104 and the thin film transistor TFT. The protective film may be formed of double layers of organic and inorganic protective films, or a single layer formed of one of organic and inorganic protective films.

The seal pattern portion 140 is formed along a periphery of the active region of the thin film transistor substrate 180, for bonding the color filter substrate 170 and the thin film transistor substrate 180 together. The seal pattern portion 140 overlaps with the black matrix 132 and the upper substrate 130 with the common electrode 136 disposed therebetween. In this instance, the upper substrate 130 is, for an example, a glass substrate. Good adhesion can be provided if the seal pattern portion 140 is formed on the glass substrate and the transparent conductive material.

According to this, the seal pattern portion 140 is formed such that a portion of the seal pattern portion 140 overlaps with the black matrix 132 and rest of the seal pattern portion 140 overlaps with the glass substrate 130.

For an example, a distance BGD from an edge of the upper substrate 130 to an edge of the black matrix 132 is about 400˜about 600 μm. In this instance, preferably, the distance BGD from the edge of the upper substrate 130 to the edge of the black matrix 132 is about 500 μm. According to this, of a width of the seal pattern portion 140, a certain portion of the width overlaps with the black matrix 132, to secure a portion GW where the black matrix 132 does not overlap with the seal pattern portion 140, but the seal pattern portion 140 overlaps with the upper substrate 130. In this instance, the portion GW where the seal pattern portion 140 overlaps with the upper substrate 130 with the common electrode 136 disposed therebetween is for, an example, about 100˜about 300 μm, and preferably about 200 μm.

Thus, the seal pattern portion 140 overlaps with the upper substrate 130 with the common electrode 136 of transparent conductive material disposed therebetween, and a step difference of the black matrix 132 which overlaps with the seal pattern portion 140 partly improves the adhesive force, to improve adhesive force between the seal pattern portion 140 and the color filter substrate 170.

Moreover, the improvement of adhesive force between the seal pattern portion 140 and the color filter substrate 170 improves the tearing off between the black matrix 132 and the common electrode 136, enabling to improve quality problems, such as corrosion and air holes.

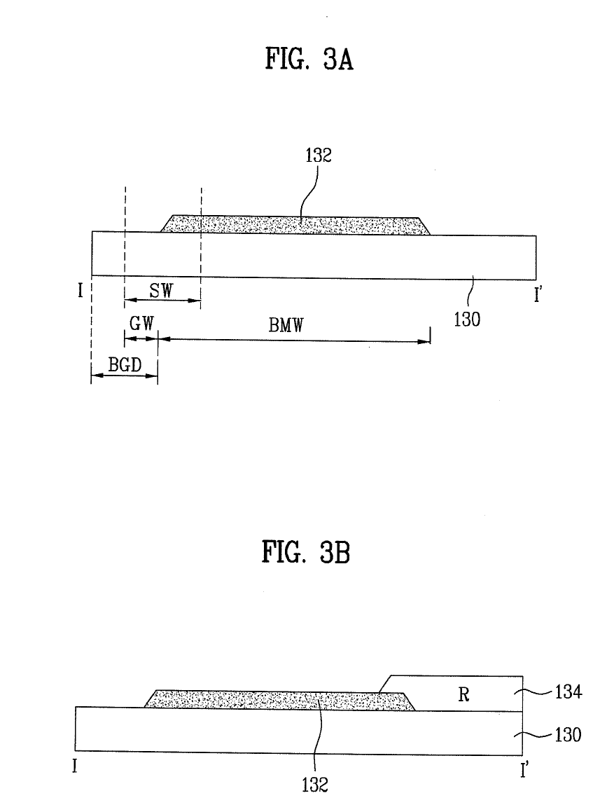

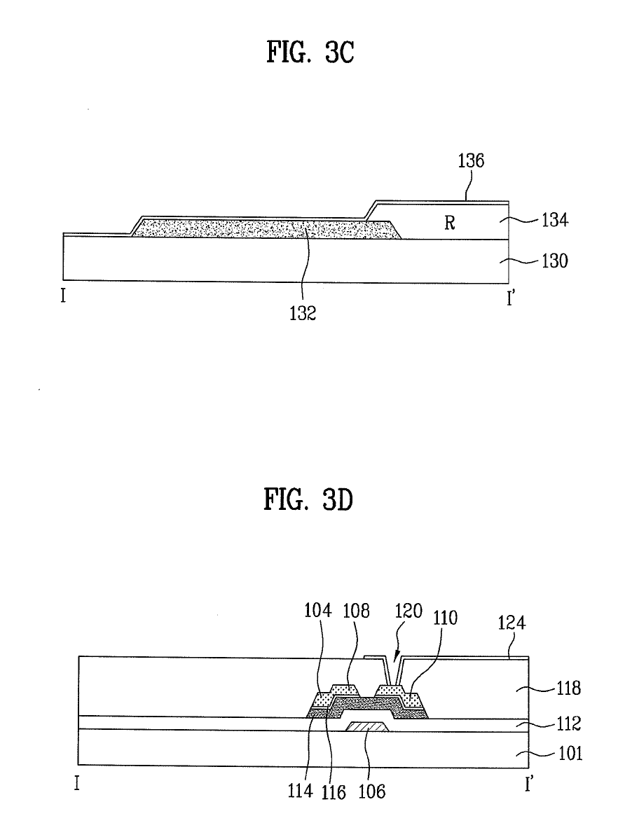

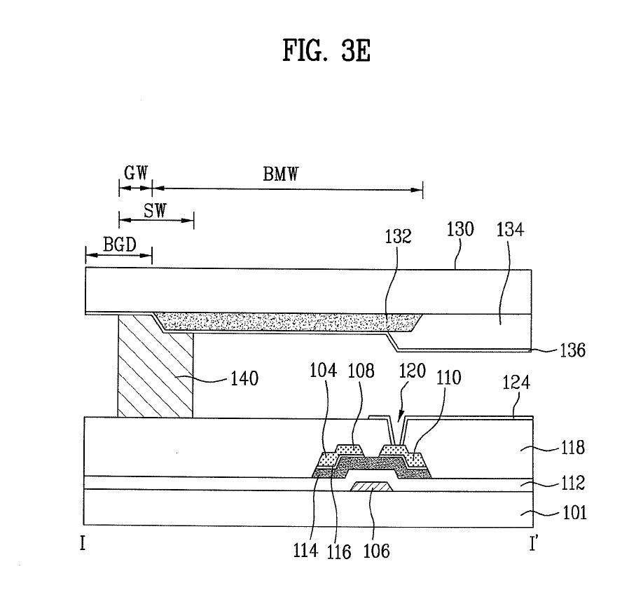

FIGS. 3A to 3E sections for describing a method for fabricating a liquid crystal display panel in accordance with a preferred embodiment.

Referring to FIG. 3A, a black matrix 132 is formed on an upper substrate 130 overlapped with a seal pattern portion.

In detail, by depositing a non-transparent metal layer or a non-transparent resin layer on the upper substrate 130, a single, double, or more than double layered black layer is formed on the upper substrate 130. Then, the black layer is subjected to patterning by a photo-etching process to form a black matrix 132.

In this instance, in order to make the black matrix 132 to overlap with the seal pattern portion 140 for a predetermined portion, the black matrix 132 formed such that a distance BGD from an edge of the upper substrate 130 to an edge of the black matrix 132 is about 400˜6 about 00 μm, preferably about 500 μm. According to this, the black matrix 132 overlaps with the seal pattern portion 140 at only a portion thereof, enabling to secure a portion GW where the black matrix 132 does not overlap with the seal pattern portion 140, but the seal pattern portion 140 overlaps with the upper substrate 130.

Referring to FIG. 3B, red R, green G, and blue B color layers having a photosensitivity are formed on the upper substrate 130 having the black matrix 132 formed thereon, and subjected to patterning by a photo etching process to form a sub-pixel region.

Referring to FIG. 3C, a common electrode 136 is formed on the upper substrate 130 having the black matrix 132 and the color filter 134 formed thereon.

In detail, the common electrode 136 is formed of a transparent conductive material by sputtering or the like. In this instance, the transparent conductive material is ITO (Indium Tin Oxide), IZO (Indium Zinc Oxide), and so on.

Referring to FIG. 3D, a thin film transistor TFT, and a pixel electrode 124 connected to a drain electrode 110 of the thin film transistor TFT are formed on a lower substrate 101.

A semiconductor layer having a gate electrode 106, a gate insulating film 112, an active layer 114, and an ohmic contact layer 116, and a thin film transistor TFT having source/drain regions, and so on are formed on the lower substrate 101. After forming a protective film 118 having a contact hole 120 formed therein on the lower substrate 101 having the thin film transistor TFT formed thereon, a pixel electrode 124 is formed on the protective film 118, which is connected to the drain electrode 110 of the thin film transistor TFT.

Referring to FIG. 3E, after applying a seal pattern portion 140 to the upper or lower substrate 101 or 130, the upper and lower substrates 101 and 130 are bonded together, to fabricate a liquid crystal display panel.

In detail, the seal pattern portion 140 is formed partly overlapped with the black matrix 132 on the upper substrate 130 with a common electrode 136 disposed therebetween, and rest of region of the seal pattern portion 140 is overlapped with the upper substrate 130. According to this, a portion of a width SW of the seal pattern portion 140 is bonded with the upper substrate 130 with the common electrode 136 disposed therebetween, thereby improving an adhesive force, and rest of the width SW of the seal pattern portion 140 is overlapped with the black matrix 132, thereby improving the adhesive force owing to a step difference of the black matrix 132.

As has been described, the liquid crystal display panel and the method for fabricating the same of the present invention have the following advantages.

The seal pattern portion is formed to overlap with the upper substrate and the black matrix with the common electrode disposed therebetween. The common electrode is formed of a transparent conductive material, and the upper substrate is formed of a glass substrate.

According to this, the contact of the seal pattern portion with the glass substrate with the transparent conductive material disposed in between improve adhesive force, and the overlap of the seal pattern portion with a portion of the black matrix improves the adhesive force owing to a step of the black matrix.

The improvement of the adhesive force between the two substrate improve tearing off between the black matrix and the common electrode, thereby improving quality problems, such as corrosion and air holes, as well as darkening and defective liquid crystal filling of the liquid crystal display panel.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A liquid crystal display panel comprising:
a black matrix on an upper substrate;
a common electrode on the black matrix;
a lower substrate having a thin film transistor thereon, the lower substrate facing the upper substrate; and
a seal pattern portion overlapped with the black matrix and the upper substrate with the common electrode disposed therebetween that bonds the upper substrate and the lower substrate together.

2. The liquid crystal display panel as claimed in claim 1, wherein the seal pattern portion overlaps with the upper substrate for a portion of about 100˜about 300 μm, with the common electrode disposed therebetween.

3. The liquid crystal display panel as claimed in claim 1, wherein a distance from an edge of the upper substrate to an edge of the black matrix is about 400˜about 600 μm.

4. The liquid crystal display panel as claimed in claim 1, wherein the upper substrate or the lower substrate comprise a glass substrate and the common electrode comprises a transparent conductive material.

5. A method for fabricating a liquid crystal display panel comprising the steps of:
forming a black matrix on an upper substrate;
forming a common electrode on the black matrix;
forming a thin film transistor on a lower substrate to face the upper substrate; and
forming a seal pattern portion to overlap with the black matrix and the upper substrate with the common electrode disposed therebetween for bonding the upper substrate and the lower substrate together.

6. The method as claimed in claim 5, wherein the seal pattern portion overlaps with the upper substrate for a portion of about 100˜about 300 μm, with the common electrode disposed therebetween.

7. The method as claimed in claim 5, wherein a distance from an edge of the upper substrate to an edge of the black matrix is about 400˜about 600 μm.

8. The method as claimed in claim 5, wherein the upper substrate or the lower substrate is formed of a glass substrate and the common electrode is formed of a transparent conductive material.
